(19) United States
(12) Patent Application Publication
(10) Pub. No.: US 2019/0212889 A1
(43) Pub. Date: Jul. 11, 2019

(54) OPERATION OBJECT PROCESSING METHOD AND APPARATUS

(71) Applicant: ALIBABA GROUP HOLDING LIMITED, GRAND CAYMAN, KY (US)

(72) Inventor: Lindong LIU, HANGZHOU (CN)

(21) Appl. No.: 16/358,382

(22) Filed: Mar. 19, 2019

Related U.S. Application Data
(63) Continuation of application No. PCT/CN2017/101523, filed on Sep. 13, 2017.

(30) Foreign Application Priority Data
Sep. 21, 2016 (CN) 201610839763.4

(51) Int. Cl. G06F 3/0484; G06F 3/0488; G06F 3/0482

(52) U.S. Cl. CPC G06F 3/0484; G06F 2203/04808; G06F 3/0482; G06F 3/04883

(57) ABSTRACT

An operation object processing method and apparatus are provided. The method comprises: receiving touch position information generated based on multi-point touch operation on a touchscreen of a terminal; determining operation objects on the terminal based on the touch position information; determining a target object set for the operation objects; and merging the operation objects into the target object set.

### CROSS-REFERENCE TO RELATED APPLICATIONS

This application is a continuation application of International Patent Application No. PCT/CN2017/101523, filed on Sep. 13, 2017, which is based on and claims priority to the Chinese Patent Application No. 201610839763.4, filed on Sep. 21, 2016 and entitled “Operation Object Processing Method and Apparatus.” The above-referenced applications are incorporated herein by reference in their entirety.

### TECHNICAL FIELD

This application relates to the field of computer technologies, and in particular, to an operation object processing method and apparatus.

### BACKGROUND

With terminals that have touchscreens, such as smart phones and tablet computers, having become popular, users can conveniently perform touch operations on the touchscreen terminals and no longer rely on input devices such as a mouse, a keyboard, and the like.

At present, an operation interface of a touchscreen of a terminal typically comprises different operation objects, such as application logos in a main interface, contacts in a list of contacts in an instant messaging application, and the like. A user can execute touch operations on the touchscreen to merge operation objects, and the merged operation objects are typically stored in an object set.

For example, in a scenario of merging logos, as shown in FIG. 1a (FIG. 1a only illustrates an interface comprising logos), a user long-presses a selected logo and uses a finger to drag the logo into a range of a target logo. At this point, the operating system of the touchscreen terminal creates a logo folder for these two logos, thereby achieving merge of the logos (the created logo folder can be deemed as an object set).

For another example, in a scenario of merging contacts, as shown in FIG. 1b (FIG. 1b only illustrates an interface comprising contacts), a user uses a finger to long-press a selected contact (e.g., contact 2 in FIG. 1b) and drag the selected contact into the range of a target contact (contact 1). At this point, the instant messaging application creates a group for these two contacts, thereby achieving merge of the contacts (the created group can also be deemed as an object set).

However, if the merge of operation objects is achieved in a dragging manner, then a user's finger needs to stay in contact with a terminal screen. In this case, if the spacing between two operation objects is big, the user's finger needs to drag for a long distance, which causes inconvenience. Moreover, fingers tend to lose the contact with the screen in the way of dragging. Once this occurs during the dragging, the user is required to perform the dragging again. In a scenario of merging a number of operation objects, the operations in the above manner need to be performed for a number of times, which is inconvenient.

In addition, current technologies also support a user to implement merge of operation objects through menu options. However, this manner also requires the user to perform operations like search, select, and the like, which is inconvenient.

### SUMMARY

Embodiments of the specification provide an operation object processing method, an operation object processing apparatus and a non-transitory computer-readable storage medium to solve the problem in current technologies that the operation process to merge operation objects is inconvenient.

According to one aspect the embodiments of the specification, the operation object processing method comprises: receiving touch position information generated based on a multi-point touch operation on a touchscreen of a terminal; determining operation objects on the terminal based on the touch position information; determining a target object set for the operation objects; and merging the operation objects into the target object set.

In some embodiments, the method further comprises: determining whether the operation objects comprise an object set, and when the operation objects do not comprise an object set, determining whether the operation objects have the same object type.

In some other embodiments, the determining a target object set for the operation objects comprises: in response to determining that the operation objects have the same object type, creating an object set for the operation objects as the target object set.

In still other embodiments, the method further comprises: determining whether the operation objects comprise one or more object sets, and when the operation objects comprise one or more object sets, determining whether objects in the one or more object sets and the operation objects other than the one or more object sets have the same object type.

In yet other embodiments, the determining a target object set for the operation objects comprises: in response to determining that objects in the one or more object sets and the operation objects other than the one or more object sets have the same object type, selecting an object set from the one or more object sets comprised in the operation objects as the target object set for the operation objects.

In other embodiments, the selecting an object set as a target object set for the operation objects comprises: receiving a selection instruction from a user; and determining an object set as the target object set for the operation objects based on the selection instruction.

In still other embodiments, the merging the operation objects comprises: merging the operation objects according to a confirmation instruction from the user.

In yet other embodiments, the receiving touch position information generated based on a multi-point touch operation comprises: receiving touch track information generated based on a multi-point gathering operation; and the determining operation objects based on the touch position information comprises: determining operation objects corresponding to starting positions of touch tracks according to the touch track information.

In other embodiments, the operation objects comprise at least one of logos, files, contacts in a communication list, and object sets; and the object sets comprise at least one of logo folders, folders for storing files, and contact groups.

In still other embodiments, the method further comprises: determining whether the operation objects comprise one or more object sets; when the operation objects comprise one or more object sets, determining whether objects in any one of the one or more object sets and the operation objects other than the one or more object sets have the same object type; and when the objects in one of the one or more object sets have the same object type as the operation objects other than the one or more object sets, determining the one as the target object set.

According to another aspect of the embodiments of the specification, the operation object processing apparatus comprises: one or more processors and one or more non-transitory computer-readable memories coupled to the one or more processors and configured with instructions executable by the one or more processors to cause the apparatus to perform operations comprising: receiving touch position information generated based on a multi-point touch operation on a touchscreen of a terminal; determining operation objects on the terminal based on the touch position information; determining a target object set for the operation objects; and merging the operation objects into the target object set.

According to yet another aspect of the embodiments of the specification, the non-transitory computer-readable storage medium storing instructions executable by one or more processors to perform operations comprising: receiving touch position information generated based on a multi-point touch operation on a touchscreen of a terminal; determining operation objects on the terminal based on the touch position information; determining a target object set for the operation objects; and merging the operation objects into the target object set.

At least one of the above aspects of the embodiments of the specification can achieve the following advantageous effect. When a user wants to merge operation objects in a terminal, the user can perform multi-point touch operations on a number of operation objects on a touchscreen of the terminal, then the terminal's touchscreen generates corresponding touch position information based on the multi-point touch operations, and the terminal's operating system can determine corresponding operation objects according to the touch position information and further determine a target object set corresponding to the operation objects, thereby merging the multiple operated operation objects. Compared with current technologies, in the above-described manner according to this application, a user does not need to perform operations of long pressing, dragging and the like on operation objects, and especially for multiple operation objects, the user can conveniently merge the multiple operation objects into a target object set by a multi-point touch.

### BRIEF DESCRIPTION OF THE DRAWINGS

The accompanying drawings herein are used to provide a further understanding of this application and constitute a part of this application. The illustrative embodiments and description of this application are used to describe this application, and do not constitute inappropriate limitation to this application. In the accompanying drawings:

FIGS. 1a and 1b are schematic diagrams of operation manners for operation objects according to current technologies;

FIG. 2a is a schematic diagram of a process for handling operation objects according to some embodiments of this application;

FIGS. 2b and 2c are schematic diagrams of an operation manner for operation objects according to some embodiments of this application;

FIGS. 2d and 2e are schematic diagrams of an operation object processing scenario according to some embodiments of this application;

FIGS. 3a-3d are schematic diagrams of examples of operation object processing according to some embodiments of this application;

FIG. 4 is a schematic structural diagram of an operation object processing apparatus according to some embodiments of this application.

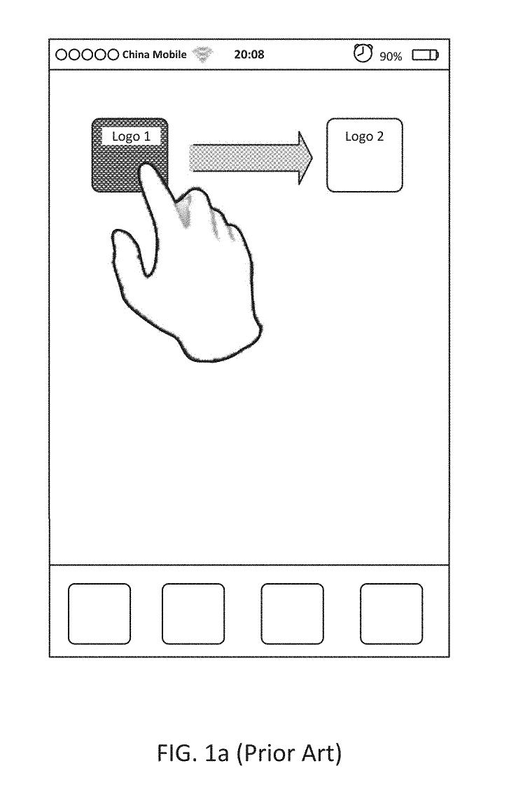

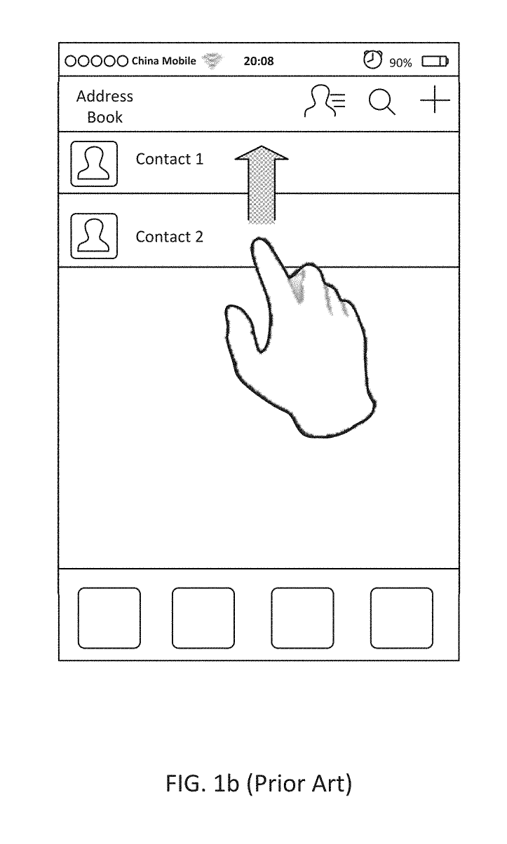

### DETAILED DESCRIPTION

To make the objectives, technical solutions, and advantages of this application clearer, the technical solutions of this application will be clearly and completely described below with reference to the embodiments and accompanying drawings of this application. Apparently, the described embodiments are merely some, but not all, embodiments of this application. All other embodiments obtainable by a person skilled in the art without creative effort and based on the embodiments of this application shall fall within the scope of this application.

As described above, in a process that a user merges operation objects displayed on a touchscreen interface, it is often necessary for the user to long-press a selected operation object and drag it into a range of a target object for merging the operation objects; alternatively, the user can merge operation objects through menu options. However, operations are inconvenient in either of these two manners.

An operation object processing method is provided in the embodiments of the specification, which enables a user to merge multiple operation objects in an interface in a multi-point touch manner. Efficiency and convenience of merging operation objects can be improved.

In some embodiments, the touchscreen terminal in the embodiments of this application includes, but is not limited to, a smart phone, a tablet computer, a smart watch, a computer, a smart home control apparatus, and the like that have touchscreen function (for ease of description, a touchscreen terminal is referred to as a “terminal” in short).

A terminal's operation interface comprises operation objects, where the operation interface can include a main interface (including a desktop), a communication list interface, or an application interface of the terminal. Correspondingly, the operation objects can comprise at least one of logos, files, contacts in a communication list, and object sets. The object sets can further comprise at least one of logo folders, folders for storing files, and contact groups.

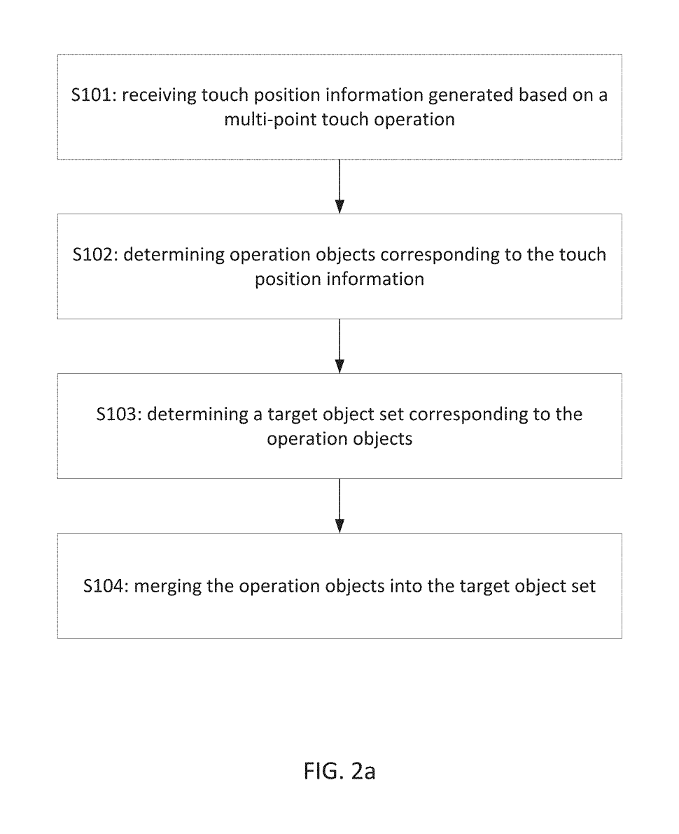

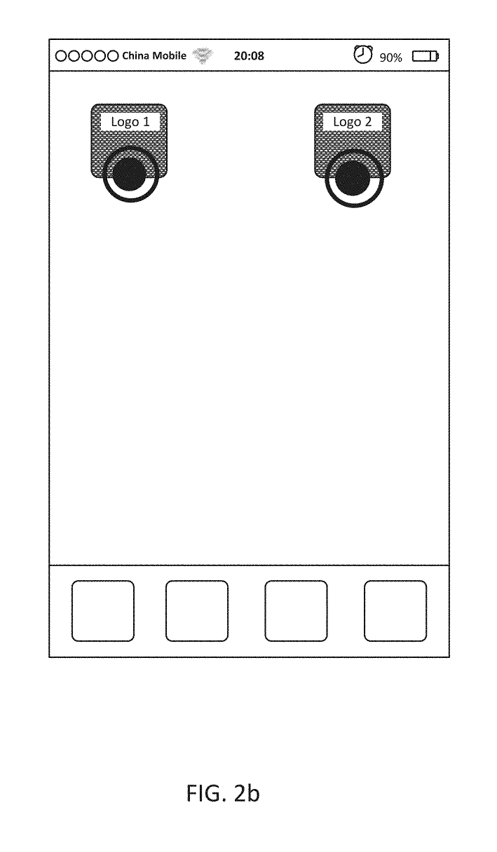

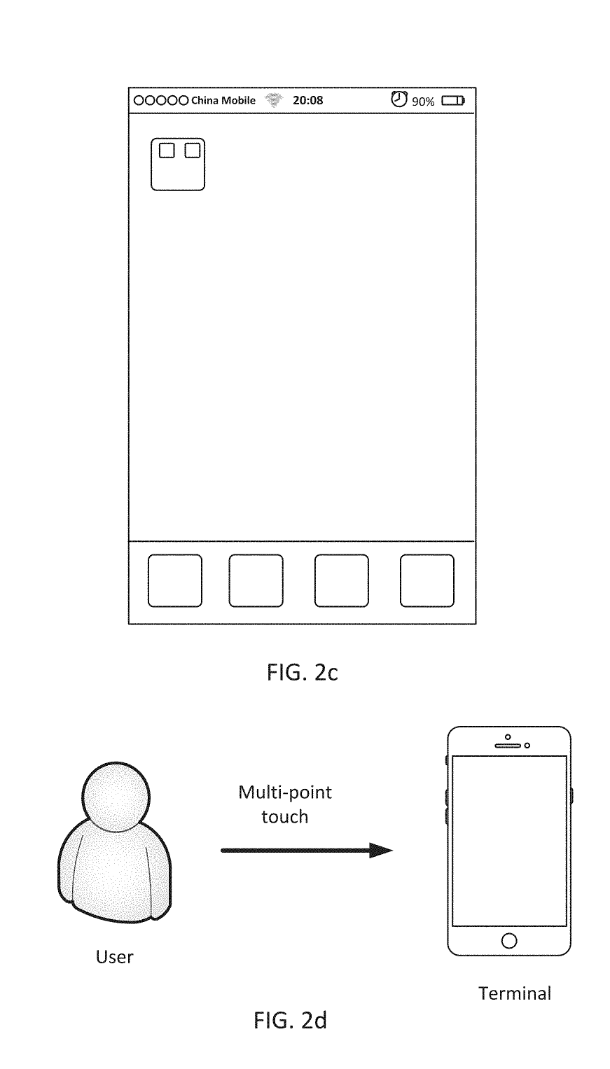

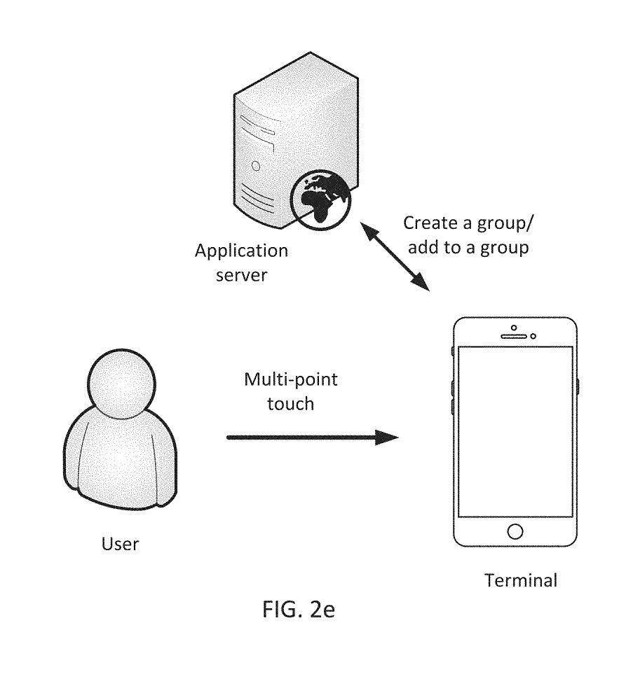

Referring to FIG. 2a, a process for handling operation objects according to some embodiments of this application comprises, for example, the following steps:

S101: receiving touch position information generated based on a multi-point touch operation.

In the embodiments of this application, the multi-point touch operation can include operations, such as touch, press, gather, and slide, at multiple positions on the terminal screen executed by the user through fingers, a touch pen, or other means. In addition, in the process that the user executes the multi-point touch operation, the multiple action points can be generated at different time. In other words, the user can touch different positions on the screen sequentially; however, the positions which have been touched by the user may need to remain in contact with the screen while the user touching other positions. Otherwise, the multi-point touch may be invalid.

In some embodiments, terminals receive touch operations through their own touchscreens. Types of touchscreens can include: resistive touchscreens, capacitive touchscreens, vector pressure sensing touchscreens, infrared touchscreens, or surface acoustic wave touchscreens. When a terminal's own touchscreen receives a multi-point touch operation, the terminal can determine, according to changes of the capacitance, resistance, pressure, infrared ray, or acoustic wave on the touchscreen, action positions of the touch operation on the screen, and then generate touch position information. The process of generating touch position information may use existing touchscreen technologies and will not be elaborated herein.

S102: determining operation objects corresponding to the touch position information.

In the embodiments of this application, different operation objects have respective position identifiers (e.g., coordinates), and the touch position information also comprises coordinates of the action positions of the touch operation. Then, operation objects corresponding to the touch position information can be determined.

In some embodiments, if the multi-point touch operation executed by the user only corresponds to one operation object, no merge of operation objects may be needed.

In some embodiments, each action point of the multi-point touch operation corresponds to a different operation object. There may be an one-to-one correspondence between the action points of the multi-point touch operation and the operation objects. Accordingly, the terminal determines that these operation objects are subjected to a touch operation, respectively.

In other embodiments, some action points of the multi-point touch operation may be repeatedly placed on the same operation object. Therefore, the operation object may correspond to two or more action points. However, the terminal may determine that the operation object is subjected to only one of the action points of touch operation. For example, the user uses fingers to execute a three-point touch operation on contacts displayed in a contact list, where the touch action points of two fingers may be both on a contact A, while the touch action point of the third finger is on a contact B. Accordingly, the terminal determines that operation objects subjected to the three-point touch operation are the contact A and the contact B.

S103: determining a target object set corresponding to the operation objects.

To merge operation objects, a target object set may be determined. In some embodiments, the target object set can be created by the terminal based on operation objects that have been operated. In some other embodiments, the target object set can be an object set in the operation objects. For example, one of the operation objects may be an object set.

S104: merging the operation objects into the target object set.

After the target object set is determined, the operated operation objects can be merged. The merge in the embodiments of this application can be regarded as adding the operation objects into the target object set.

In some embodiments, the merge of operation objects in a terminal, such as logos or files, includes adding the operation objects into a corresponding target folder (such as a logo folder or a folder for storing files) by changing the storage paths of these operation objects.

The merge of operation objects, such as contacts, includes establishing an association among the operation objects, such that the operation objects belong to the same contact group.

Based on the above description, in some embodiments, a user can use multi-point touch to merge a number of operation objects. As shown in FIG. 2b, in a main interface of a terminal, a user performs touches on two logos, respectively (the rings in FIG. 2b represent action points of the touches, and this description will not be repeated for their appearance in subsequent figures), to form a logo folder on the terminal, as shown in FIG. 2c. In FIG. 2c, the logo folder comprises a logo 1 and a logo 2. The example only uses logos as operation objects for description, while operation objects in other examples are not limited to logos, but can be files, contact options, and other operation objects.

Through the above-described steps, when the user wants to merge the operation objects in the terminal, the user can execute a multi-point touch operation on a number of operation objects. Then, the touchscreen of the terminal generates corresponding touch position information based on the multi-point touch operation. The terminal's operating system can determine, according to the touch position information, corresponding operation objects and further determine a target object set corresponding to the operation objects, thereby merging the operated operation objects. Compared with current technologies, in the above manner of this application, a user does not need to execute operations like long pressing and dragging on operation objects, and especially for multiple operation objects, the user can conveniently merge the multiple operation objects into a target object set by a multi-point touch.

With regard to the above description, if operation objects belong to the terminal itself, e.g., logos, files, and the like, of the terminal, the terminal's own operating system can merge the operation objects. Namely, as shown in FIG. 2d, the user operates on the terminal, and the terminal's operating system acts as the execution entity to merge the operation objects.

If operation objects belong to an application on the terminal, e.g., contacts in an instant messaging application, the corresponding function in the application generates an operation object merging request and sends the request to a server corresponding to the application for processing. In other words, as shown in FIG. 2e, the server can act as the execution entity to merge the operation objects. For the server, to create a group for different contacts/add some contacts into a group essentially is to establish an association among different contacts, and the server saves the association. For example, corresponding association can be established based on account identifiers of different contacts and a group identifier.

Moreover, in some embodiments, operation objects on which a touch operation acts may be displayed simultaneously on a terminal screen. In other embodiments, if some operation objects are on the current page (the page displayed on the terminal screen) while other operation objects are on another page (the page not displayed on the terminal screen), a user may not execute a touch operation on the operation objects that are not displayed.

In some embodiments, a user may execute a multi-point touch operation on logos or files to add the logos or files to a corresponding folder; for contacts, the user may execute a multi-point touch operation to add a number of contacts to a corresponding group. However, if the operation objects acted on by the multi-point touch operation include both logos or files and contacts, then the terminal cannot merge the operation objects.

Therefore, in a general scenario, the operated operation objects in a process of merging the operation objects have the same object type.

The process of merging operation objects in a general scenario will be described in detail below.

When a user intends to merge a plurality of logos into one logo folder, or when the user intends to create a group for a number of contacts, the user can execute a multi-point touch operation on the above operation objects to merge the operation objects. The operation objects acted on by the touch operation do not include an object set. For example, the operation objects acted on by the touch operation are logos, files or contacts. In some embodiments, before determining a target object set corresponding to the operation objects, the method further comprises: determining that the operation objects corresponding to the touch position information have the same object type.

Furthermore, the process of determining a target object set corresponding to the operation objects comprises: creating an object set for the operation objects, and determining the created object set as a target object set corresponding to the operation objects.

In some embodiments, after receiving the multi-point touch operation, the terminal determines that all operation objects acted on by the multi-point touch operation are of the same object type. For example, all operation objects acted on by the multi-point touch operation are logos, files, or contacts. These operation objects do not have any object set. The terminal may create an object set for these operated operation objects. For example, the terminal may create a logo folder for the operated logos. In another example, the terminal may create a contact group for the operated contacts. The object set created by the terminal is used as the target object set. In the subsequent process, the terminal may add operated operation objects into the created target object set.

In other embodiments, once the operation objects acted on by the multi-point touch operation comprise different types of operation objects, the multi-point touch operation may be determined as an invalid operation, and the terminal can make no response to the operation.

In addition, in some embodiments, a user may want to add a number of logos into a logo folder which has been created, or the user may want to add a number of contacts into a contact folder which has been created. Then, the user can execute a multi-point touch operation on the logos (or contacts) and the corresponding logo folder (or contact group) to add the operation objects into the corresponding object set (e.g., the logo folder or contact group). The operation objects acted on by the touch operation may include one or more object sets. In some embodiments, if objects in the one or more object sets have a different type from that of the operation objects other than the one or more object sets, then the terminal cannot merge these operation objects. In other words, when one of the operation objects is an object set (e.g., a file folder), objects in the object set (e.g., files in the file folder) may be compared with the other operation objects (i.e., the operation objects other than the object set) acted on by the touch operation to determine whether they have the same type.

For example, assuming that the operation objects acted on by a touch operation include a contact group, which can be regarded as an object set, and the contact group includes multiple contacts, which can be regarded as objects in the object set, and assuming that the operation objects acted on by the touch operation also include a number of logos, the logos cannot be merged into the contact group as the logos and the contacts in the contact group do not belong to the same type.

Therefore, before determining a target object set corresponding to the operation objects, the method further comprises: determining that objects in the one or more object sets and the operation objects other than the one or more object sets have the same object type. Furthermore, determining a target object set corresponding to the operation objects comprises: selecting an object set from the one or more object sets comprised in the operation objects and determining the selected object set as a target object set corresponding to the operation objects.

In some embodiments, a number of operation objects corresponding to the touch operation may include only one object set. Then, the object set is determined to be the target object set. For example, a user executes a multi-point touch operation on two logos and one logo folder, then the logo folder can be determined to be the target object set, and the terminal can subsequently add these two logos into the logo folder.

In other embodiments, a number of operation objects corresponding to the touch operation may include two or more object sets. Then, the terminal selects one object set as the target object set. For example, the terminal can randomly select one of the object sets, or the selection can be made by the user. When the selection is made by the user, selecting and determining an object set as the target object set may include receiving a selection instruction from the user, and determining an object set corresponding to the selection instruction as the target object set.

In some embodiments, the terminal can use a pop-up, a floating interface, or other manners to display a selection interface. The selection interface includes the one or more object sets acted on by the multi-point touch operation, and the user can select one of the object sets displayed in the selection interface. The terminal then determines the object set selected by the user as the target object set.

In the process of merging operation objects, if the operation objects are logos or files in the terminal or contacts in the terminal's address book, then the terminal can create a corresponding target object set or add the operation objects other than any object set into an existing object set. On the other hand, if the operation objects acted on by the multi-point touch operation are objects in an application (e.g., contacts in an instant messaging application), then the terminal sends, according to the multi-point touch operation by the user, a request for creating a target object set or an addition request to a server corresponding to the application, and the server creates a corresponding target object set or adds the operation objects into an existing object set. For example, if the server creates a group, the group may include all contacts operated by the user and the user himself/herself.

In addition, the terminal can display a corresponding confirmation interface to the user, and the user can execute a corresponding confirmation operation in the confirmation interface, including: confirming whether to create a target object set, editing the name of the target object set, confirming whether to add the operation objects that are not an object set into the target object set, and the like. Therefore, merging the operation objects may comprise: merging the operation objects according to a confirmation instruction sent by the user.

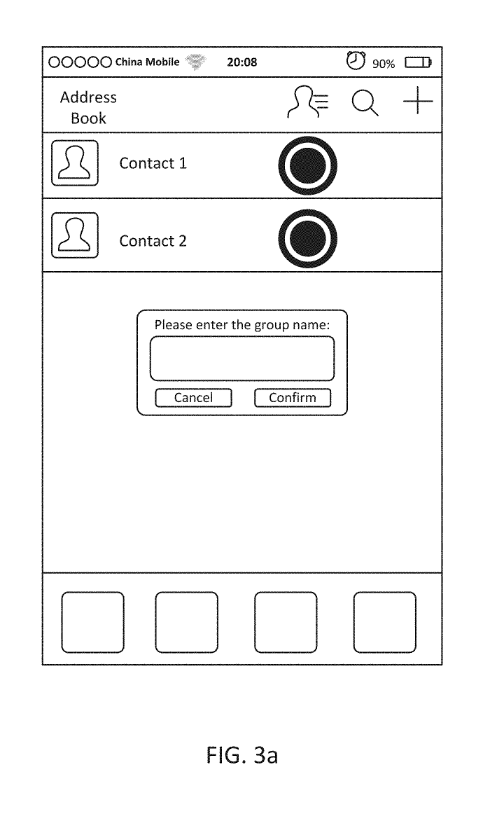

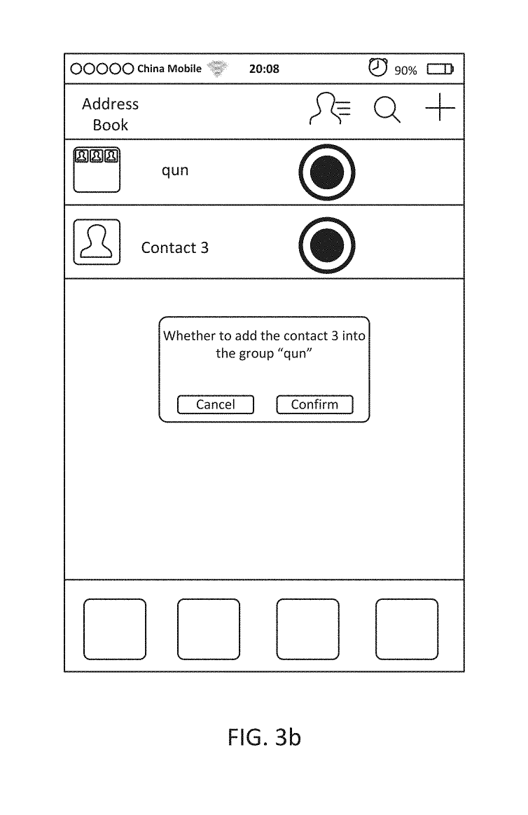

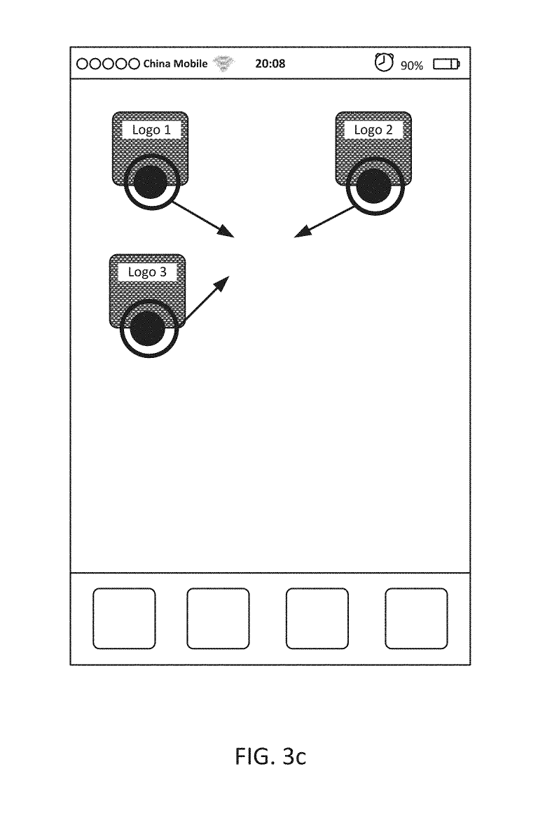

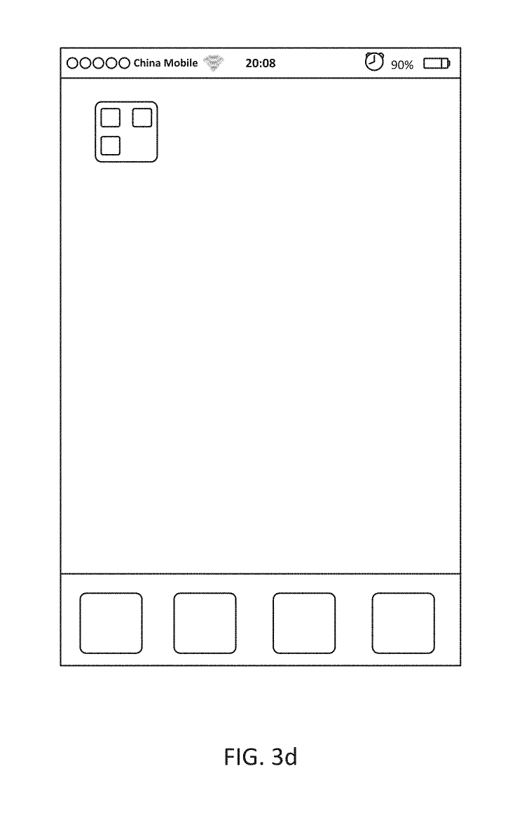

For example, assuming that the user executes a touch operation on two contacts 1 and 2, then the terminal can display a confirmation interface to the user, as shown in FIG. 3a. In the confirmation interface, the user can input and edit the group name. For example, the user may enter “qun” as the group name. After the confirmation is clicked, the application may create a corresponding group “qun.” The group “qun” comprises the contact 1, the contact 2, and the user.

In another example, assuming that the user executes a touch operation on a contact 3 and the group “qun” created in the above example, then the terminal can display a confirmation interface to the user, as shown in FIG. 3b. In the confirmation interface, the user can determine whether to add the contact 3 into the group “qun.” If the confirmation is selected, the application adds the contact 3 into the group “qun.”

In other embodiments, a multi-point touch operation issued by the user may be a multi-point gathering operation. For example, as shown in FIG. 3c, the user executes a multi-point gathering operation on three logos, such as logo 1, logo 2, and logo 3, in the terminal interface. The black arrows in FIG. 3c represent the gathering directions of the user's fingers.

As shown in FIG. 3c, receiving touch position information generated based on a multi-point touch operation may include receiving touch track information generated based on a multi-point gathering operation. Then, determining operation objects corresponding to the touch position information may include determining operation objects corresponding to starting positions of touch tracks according to the touch track information. The operation objects corresponding to the starting positions of the touch tracks are operation objects acted on by the multi-point gathering operation. After the operation object set is determined, the above-described merging process can be executed, which will not be repeated herein.

Using the example shown in FIG. 3c, the terminal can merge the three logos into the same logo folder as shown in FIG. 3d.

With reference to the above description, using a multi-point touch in the embodiments of this application, a user can conveniently achieve rapid merge of operation objects on an interface. Based on the same concept, the embodiments of this application further provide an operation object processing apparatus.

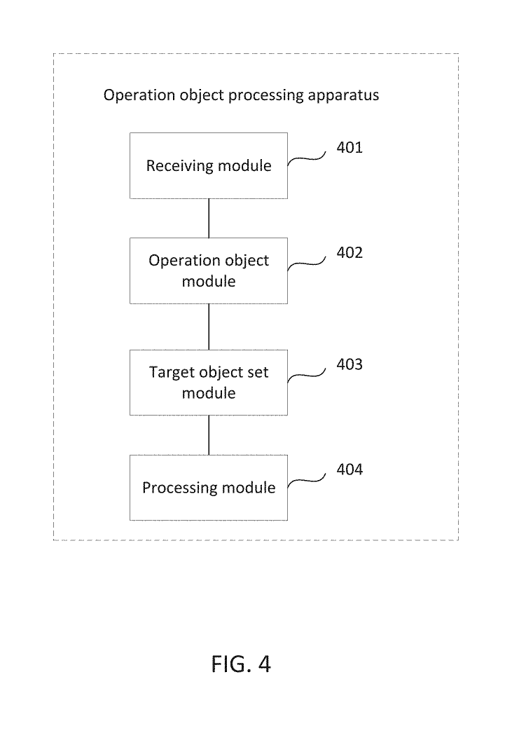

As shown in FIG. 4, the operation object processing apparatus comprises: a receiving module 401 configured to receive touch position information generated based on a multi-point touch operation; an operation object module 402 configured to determine operation objects corresponding to the touch position information; a target object set module 403 configured to determine a target object set corresponding to the operation objects; and a processing module 404 configured to merge the operation objects into the target object set.

In some embodiments, when the operation objects do not include an object set, the operation object module 402 determines that the operation objects corresponding to the touch position information have the same object type. The target object set module 403 creates an object set for the operation objects, and determines the created object set as the target object set corresponding to the operation objects.

In other embodiments, when the operation objects include one or more object sets, the operation object module 402 determines that objects in the one or more object sets and the operation objects other than the one or more object sets have the same object type. The target object set module 403 selects an object set from the one or more object sets included in the operation objects and determines the selected object set as the target object set corresponding to the operation objects.

Furthermore, the target object set module 403 may receive a selection instruction from the user, and determine an object set corresponding to the selection instruction as the target object set corresponding to the operation objects.

The processing module 404 receives a confirmation operation from the user and merges the operation objects according to the confirmation instruction issued by the user.

A multi-point touch operation can also include a multi-point gathering operation. Then, the receiving module 401 receives touch track information generated based on the multi-point gathering operation. The determining module 402 determines operation objects corresponding to starting positions of touch tracks according to the touch track information.

In some embodiments, the operation objects include at least one of logos, files, contacts in a communication list, and object sets; and the object sets comprise at least one of logo folders, folders for storing files, and contact groups.

The present invention is described with reference to the flow charts and/or block diagrams of the method, device (system), and computer program product according to the embodiments of the present invention. It should be understood that every process and/or block of the flow charts and/or block diagrams and a combination of processes and/or blocks of the flow charts and/or block diagrams can be implemented by computer program instructions. These computer program instructions can be provided to a general-purpose computer, a dedicated computer, an embedded processor, or a processor of another programmable data processing device, thereby producing a machine and causing the instructions to, when executed by the computer or the processor of another programmable data processing device, produce an apparatus for implementing functions specified in one or more processes in the flow charts and/or one or more blocks in the block diagrams.

These computer program instructions can also be stored in a computer readable storage medium capable of guiding a computer or other programmable data processing devices to work in a particular manner, causing the instructions stored in the computer readable storage medium to produce a manufactured article that includes an instruction device for implementing functions specified in one or more processes in the flow charts and/or one or more blocks in the block diagrams.

These computer program instructions can also be loaded onto a computer or other programmable data processing devices, causing a series of operation steps to be executed on the computer or other programmable data processing devices to produce a process of computer implementation. As a result, the instructions executed on the computer or other programmable data processing devices provide steps to implement functions specified in one or more processes in the flow charts and/or one or more blocks in the block diagrams.

In a typical configuration, a computation device includes one or more processors (CPUs), input/output interfaces, network interfaces, and a memory.

The memory may include computer readable media, such as a volatile memory, a Random Access Memory (RAM), and/or a non-volatile memory, e.g., a Read-Only Memory (ROM) or a flash RAM. The memory is an example of a computer readable medium.

Computer readable media include permanent, volatile, mobile and immobile media, which can implement information storage through any method or technology. The information may be computer readable instructions, data structures, program modules or other data. Examples of storage media of computers include, but are not limited to, Phase-change RAMs (PRAMs), Static RAMs (SRAMs), Dynamic RAMs (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, cassettes, cassette and disk memories or other magnetic memory devices or any other non-transmission media, which can be used for storing information accessible to a computation device. According to the definitions herein, the computer readable media do not include transitory media, such as modulated data signals and carriers.

It should be further noted that the terms of “including,” “comprising” or any other variants thereof intend to encompass a non-exclusive inclusion, causing a process, method, commodity or device comprising a series of elements to not only comprise these elements, but also comprise other elements that are not specifically listed, or further comprise elements that are inherent to the process, method, commodity or device. When there is no further restriction, elements defined by the statement “comprising one . . . ” do not exclude that a process, method, commodity or device comprising the above elements further comprises additional identical elements.

A person skilled in the art should understand that the embodiments of this application may be provided as a method, a system, or a computer program product. Therefore, this application may be implemented as a complete hardware embodiment, a complete software embodiment, or an embodiment combing software and hardware. Moreover, this application may be in the form of a computer program product implemented on one or more computer usable storage media (including, but not limited to, a magnetic disk memory, CD-ROM, an optical memory, and the like) comprising computer usable program codes therein.

Only embodiments of this application are described above, which are not used to limit this application. To a person skilled in the art, this application may have various modifications and variations. Any modification, equivalent substitution or improvement made within the spirit and principle of this application shall be encompassed by the claims of this application.

What is claimed is:

1. An operation object processing method, comprising:
receiving touch position information generated based on a multi-point touch operation on a touchscreen of a terminal;
determining operation objects on the terminal based on the touch position information;
determining a target object set for the operation objects; and
merging the operation objects into the target object set.

2. The method according to claim 1, further comprising:
determining whether the operation objects comprise an object set, and when the operation objects do not comprise an object set, determining whether the operation objects have the same object type.

3. The method according to claim 2, wherein the determining a target object set for the operation objects comprises:
in response to determining that the operation objects have the same object type, creating an object set for the operation objects as the target object set.

4. The method according to claim 1, further comprising:
determining whether the operation objects comprise one or more object sets, and when the operation objects comprise one or more object sets, determining whether objects in the one or more object sets and the operation objects other than the one or more object sets have the same object type.

5. The method according to claim 4, wherein the determining a target object set for the operation objects comprises:
in response to determining that objects in the one or more object sets and the operation objects other than the one or more object sets have the same object type, selecting an object set from the one or more object sets comprised in the operation objects as the target object set for the operation objects.

6. The method according to claim 5, wherein the selecting an object set as a target object set for the operation objects comprises:
receiving a selection instruction from a user; and
determining an object set as the target object set for the operation objects based on the selection instruction.

7. The method according to claim 1, wherein the merging the operation objects comprises:
merging the operation objects according to a confirmation instruction from the user.

8. The method according to claim 1, wherein the receiving touch position information generated based on a multi-point touch operation comprises:
receiving touch track information generated based on a multi-point gathering operation; and
the determining operation objects based on the touch position information comprises:
determining operation objects corresponding to starting positions of touch tracks according to the touch track information.

9. The method according to claim 1, wherein the operation objects comprise at least one of logos, files, contacts in a communication list, and object sets; and
the object sets comprise at least one of logo folders, folders for storing files, and contact groups.

10. The method according to claim 1, further comprising:
determining whether the operation objects comprise one or more object sets;
when the operation objects comprise one or more object sets, determining whether objects in any one of the one or more object sets and the operation objects other than the one or more object sets have the same object type; and
when the objects in one of the one or more object sets have the same object type as the operation objects other than the one or more object sets, determining the one as the target object set.

11. An operation object processing apparatus, comprising: one or more processors and one or more non-transitory computer-readable memories coupled to the one or more processors and configured with instructions executable by the one or more processors to cause the apparatus to perform operations comprising:
receiving touch position information generated based on a multi-point touch operation on a touchscreen of a terminal;
determining operation objects on the terminal based on the touch position information;
determining a target object set for the operation objects; and
merging the operation objects into the target object set.

12. The apparatus according to claim 11, wherein the operations further comprise:
determining whether the operation objects comprise an object set, and when the operation objects do not comprise an object set, determining whether the operation objects have the same object type.

13. The apparatus according to claim 11, wherein the determining a target object set for the operation objects comprises: in response to determining that the operation objects have the same object type, creating an object set for the operation objects as the target object set.

14. The apparatus according to claim 11, wherein the operations further comprise:
determining whether the operation objects comprise one or more object sets, and when the operation objects comprise one or more object sets, determining whether objects in the one or more object sets and the operation objects other than the one or more object sets have the same object type.

15. The apparatus according to claim 14, wherein the determining a target object set for the operation objects comprises:
in response to determining that objects in the one or more object sets and the operation objects other than the one or more object sets have the same object type, selecting an object set from the one or more object sets comprised in the operation objects as the target object set for the operation objects.

16. The apparatus according to claim 15, wherein the selecting an object set as a target object set for the operation objects comprises:
receiving a selection instruction from a user; and
determining an object set as the target object set for the operation objects based on the selection instruction.

17. The apparatus according to claim 11, wherein the receiving touch position information generated based on a multi-point touch operation comprises:
receiving touch track information generated based on a multi-point gathering operation; and
the determining operation objects based on the touch position information comprises:
determining operation objects corresponding to starting positions of touch tracks according to the touch track information.

18. The apparatus according to claim 11, wherein the operations further comprise:
determining whether the operation objects comprise one or more object sets;
when the operation objects comprise one or more object sets, determining whether objects in any one of the one or more object sets and the operation objects other than the one or more object sets have the same object type; and
when the objects in one of the one or more object sets have the same object type as the operation objects other than the one or more object sets, determining the one as the target object set.

19. A non-transitory computer-readable storage medium storing instructions executable by one or more processors to perform operations comprising:
receiving touch position information generated based on a multi-point touch operation on a touchscreen of a terminal;
determining operation objects on the terminal based on the touch position information;
determining a target object set for the operation objects; and
merging the operation objects into the target object set.

20. The non-transitory computer-readable storage medium in claim 19, wherein the operations further comprise: determining whether the operation objects comprise an object set, and when the operation objects do not comprise an object set, determining whether the operation objects have the same object type.
